(19) United States
(12) Patent Application Publication
(10) Pub. No.: US 2026/0284527 A1
(43) Pub. Date: Sep. 24, 2026

(54) INFORMATION PROCESSING SYSTEM, METHOD, AND NON-TRANSITORY COMPUTER-READABLE STORAGE MEDIA

(71) Applicant: Nintendo Co., Ltd., Kyoto-shi (JP)

(72) Inventors: Ryota OIWA, Kyoto-shi (JP); Masayoshi KOBAYASHI, Kyoto-shi (JP)

(21) Appl. No.: 19/569,986

(22) Filed: Mar. 17, 2026

(30) Foreign Application Priority Data
Mar. 24, 2025 (JP) 2025-048511

(51) Int. Cl. A63F 13/52; A63F 13/87

(52) U.S. Cl. CPC A63F 13/52; A63F 13/87

(57) ABSTRACT

An information processing system is an information processing system capable of executing a chat application and a game application. The chat application performs a chat with another information processing device and has a chat screen shown, the chat screen including a streaming image of another information processing device performing the chat. A display position of the streaming image is determined based on the running game application.

This non-provisional application is based on Japanese Patent Application No. 2025-048511 filed with the Japan Patent Office on Mar. 24, 2025, the entire contents of which are hereby incorporated by reference.

### FIELD

The present disclosure relates to an information processing system, a method, and non-transitory computer-readable storage media.

### BACKGROUND AND SUMMARY

A chat system using an image or voice and sound has been known.

There is room for improvement in determination of a display position of a streaming image streamed from another information processing device.

(Configuration 1) An exemplary embodiment provides an information processing system capable of executing a chat application and a game application. The chat application, by being executed, may perform a chat with another information processing device, have a chat screen shown, the chat screen including a streaming image of at least another information processing device that is performing the chat, and determine a display position of the streaming image within the chat screen based on the running game application.

(Configuration 2) In Configuration 1, positions of a plurality of areas where streaming images can be shown within the chat screen may be determined in advance, and the information processing system may determine based on the running game application, in which of the areas the streaming image of which of information processing devices is to be shown.

(Configuration 3) In Configuration 1 or 2, the game application, by being executed, may provide a communication game with at least one of other devices that are performing the chat, and the information processing system may determine the display position of the streaming image of another information processing device that is together executing the communication game.

(Configuration 4) In Configuration 3, the determined display position may be identical to the display position of the streaming image in the another device that is together executing the communication game.

(Configuration 5) In Configuration 3 or 4, the information processing system may determine the display position of the streaming image such that streaming images of a plurality of information processing devices that are together executing the communication game are vertically or laterally adjacent.

(Configuration 6) In any of Configurations 3 to 5, the information processing system may determine the display position of the streaming image within the chat screen, based on a state of execution of the running game application.

(Configuration 7) In Configuration 6, the state of execution of the game application may be correspondence between a plurality of players and a plurality of information processing devices in the game application.

(Configuration 8) In Configuration 6 or 7, the state of execution of the game application may vary while the game application is running, and the display position of the streaming image within the chat screen may vary in correspondence with variation in state of execution.

(Configuration 9) In any of Configurations 1 to 8, the chat application may determine the display position of the streaming image in accordance with a request using an application programming interface from the running game application.

(Configuration 10) In any of Configurations 1 to 9, the streaming image may include a game image of another information processing device.

(Configuration 11) An exemplary embodiment provides non-transitory computer-readable storage media that, when executed by a computer, allow the computer to provide a chat function and a game function. The chat function may include performing a chat with another information processing device, showing a chat screen including a streaming image of at least another information processing device that is performing the chat, and determining a display position of the streaming image within the chat screen based on the provided game function.

(Configuration 12) An exemplary embodiment provides a method performed by a computer. The method may include performing a chat with another information processing device, showing a chat screen including a streaming image of at least another information processing device that is performing the chat, and determining a display position of the streaming image within the chat screen based on a game application that is being executed.

(Configuration 13) An exemplary embodiment provides a program that, when executed by a computer, causes the computer to perform chat processing. The chat processing may include performing a chat with another information processing device, showing a chat screen including a streaming image of at least another information processing device that is performing the chat, and determining a display position of the streaming image within the chat screen based on a running game application.

(Configuration 14) An exemplary embodiment provides non-transitory computer-readable storage media including a game program executed by a computer. The game program may cause the computer to perform game processing and may cause a running chat application to issue a request. The request may be a request for designation of a display position of a streaming image of another information processing device that is performing a chat, the streaming image being included in a chat screen shown by the running chat application.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating a schematic diagram showing an exemplary configuration of a system according to the present embodiment.

FIG. 2 shows an exemplary illustrative non-limiting drawing illustrating a schematic diagram showing an exemplary hardware configuration of a game device according to the present embodiment.

FIG. 3 shows an exemplary illustrative non-limiting drawing illustrating a schematic diagram showing an exemplary software configuration of the game device according to the present embodiment.

FIGS. 4 to 6 each show an exemplary illustrative non-limiting drawing illustrating an exemplary chat screen generated in the game device according to the present embodiment.

FIG. 7 shows an exemplary illustrative non-limiting drawing illustrating a sequence for illustrating exemplary processing according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

Even when data is explained in identical terms, contents of the data do not have to completely match. In an example where both of one piece of data and another piece of data at least convey specific information, they may be regarded as the same data. A name of data is given for the sake of convenience, and does not limit the scope indicated by the data or the technical meaning thereof.

A program that causes a computer to perform processing may be a single program or a program group including a plurality of programs. “A program” in the present disclosure does not have to mean a single program but may include a program group. “A program” does not have to entirely be stored in a single device. “A program” may mean, for example, the entirety of a plurality of programs stored in respective devices included in a computer.

### [A. Exemplary System Configuration]

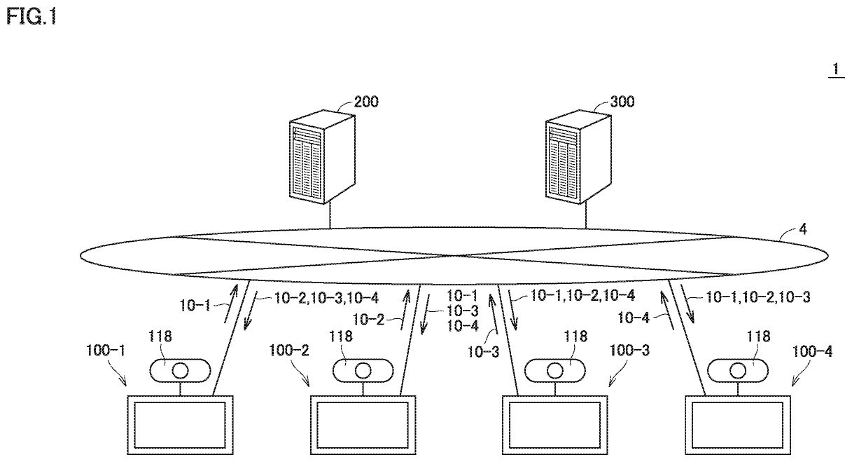

A schematic diagram showing an exemplary configuration of a system 1 according to the present embodiment will be described with reference to FIG. 1. System 1 includes one or more game devices 100. Camera 118 is available in at least one of game devices 100. FIG. 1 shows an exemplary configuration of system 1 including four game devices 100 connected to a network 4. When each of a plurality of game devices 100 should be specified in the description below, a sub number will be given for distinction (for example, game devices 100-1, 100-2, 100-3, and 100-4 shown in FIG. 1).

In system 1 according to the present embodiment, a user who uses game device 100 has the user's own account and the user's own account is brought in correspondence with each game device 100. The user who has the account can cause the account brought in correspondence to join one or more chat groups (which are also abbreviated as a “group” below) by providing predetermined input to game device 100. Game device 100 corresponding to the account belonging to at least one group transmits data (which is also referred to as “communication data 10” below) to be used for communication between users to another game device 100 corresponding to another account belonging to the group. It can also be said that game device 100 can transmit communication data 10 to another game device 100 belonging to the group the same as the group to which game device 100 belongs. Communication between users can thus be realized in the group. “Communication” or “chat” in the present embodiment may mean transmission of at least one of an image (which may include, for example, a game image, a camera image, and a text image) and sound which may include voice to another game device 100. For example, unilateral transmission only of a game image of a game application executed by one game device 100 from one game device 100 to another game device 100 may also be encompassed in “chat” or “communication”. An account does not have to be brought in correspondence with each game device 100. The “account” may be read as the “game device” and vice versa.

Communication data 10 may include, for example, sound data obtained by game device 100, image data obtained by game device 100, text data obtained by game device 100, information on an application running in game device 100, or the like. All pieces of data do not have to be included in one piece of communication data 10, and one piece of data may be divided into a plurality of pieces of communication data 10. One piece of communication data 10 may include a plurality of pieces of data.

“Image data” herein encompasses data of moving images and data of one or more still images. For example, image data may be data captured by camera 118 or the like or data outputted from an application executed in game device 100. A method of generating image data is not limited.

System 1 may further include a management server 200 and a relay server 300. Management server 200 is responsible for processing for newly forming a group, processing for participation of one or more accounts in a group, or the like. Relay server 300 relays communication data 10 to be transmitted or received by one or more game devices 100. Management server 200 and relay server 300 may be implemented at a single physical server.

A scheme to transmit communication data 10 from certain game device 100 to one or more other game devices 100 may be a scheme to directly transmit communication data 10 to one or more other game devices 100 (for example, P2P or the like), in addition to or instead of a scheme to transmit data through one or more relay entities (for example, relay server 300).

### [B. Exemplary Hardware Configuration of Game Device 100]

Game device 100 which is an exemplary information processing device will now be described. The information processing device is not limited to game device 100, and it may be, for example, a personal computer, a television, a tablet terminal, a smartphone, a wearable terminal, a server, or the like.

Game devices 100 corresponding to a plurality of accounts belonging to an identical group do not have to be identical in hardware configuration. For example, at least one of game devices 100 may be a device exclusive for games, and another game device 100 may be a personal computer, a television, a tablet terminal, a smartphone, a wearable terminal, a server, or the like capable of executing a game application. Game device 100 should only be a computer capable of executing at least a game application.

The “computer” herein does not necessarily mean a single device but may encompass the entirety in which a plurality of devices are connected by wired connection or wireless connection. In an example where the information processing device is configured with a plurality of devices, each of the plurality of devices may be an exemplary information processing device.

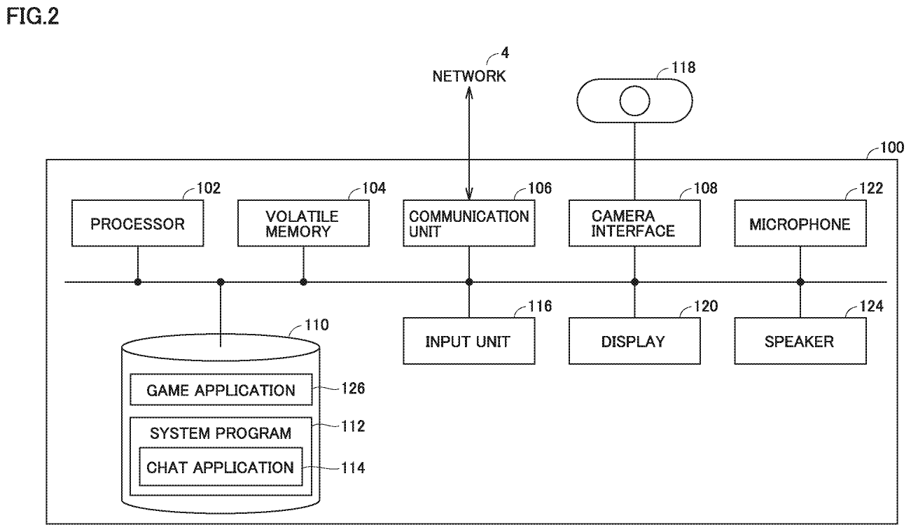

A schematic diagram showing an exemplary hardware configuration of game device 100 according to the present embodiment will be described with reference to FIG. 2. Referring to FIG. 2, game device 100 includes, for example, one or more processors 102, one or more volatile memories 104, a communication unit 106, a camera interface 108, one or more non-volatile memories 110, an input unit 116, a display 120, a microphone 122, and a speaker 124. Each component may be removable from a main body of game device 100.

Processor 102 is a processing entity for performing processing in game device 100. Processor 102 includes, for example, a central processing unit (CPU), a graphics processing unit (GPU), or the like. Processor 102 develops a program stored in non-volatile memory 110 on volatile memory 104 and executes the same.

Volatile memory 104 is a volatile storage medium accessible by processor 102, and it includes, for example, a dynamic random access memory (DRAM), a static random access memory (SRAM), or the like.

Non-volatile memory 110 is a non-volatile storage medium accessible by processor 102, and it includes, for example, a flash memory, a hard disk, or the like. Non-volatile memory 110 may include, for example, a storage medium attachable to and removable from game device 100, such as a cartridge or an optical disc. Non-volatile memory 110 is also referred to as a storage.

For example, one or more programs such as a system program 112 and a game application 126 are stored in non-volatile memory 110.

System program 112 includes computer readable instructions for hardware control of game device 100, provision of a program execution environment, or the like.

System program 112 may include one or more programs or program modules. For example, system program 112 includes a chat application 114.

Chat application 114 performs processing relating to transmission and reception of communication data 10 between a plurality of game devices 100 corresponding to a plurality of accounts belonging to a group.

Game application 126 includes computer readable instructions for execution of a game. A plurality of game applications 126 may be installed in game device 100. Game application 126 may be read from a separate storage medium. Another game device 100 or an external resource such as a server may be used for at least a part of execution of a game by game application 126. System program 112 may include at least a part of game application 126.

The “processor” herein may encompass at least processing circuitry that performs processing in accordance with computer readable instructions, such as a CPU or a GPU and hard-wired circuitry such as an application specific integrated circuit (ASIC) or a field programmable gate array (FPGA). The “memory” herein may encompass at least volatile memory 104 and non-volatile memory 110 and may include other storage media and storage devices.

In game device 100, a system on chip (SoC) in which functions of the processor, the memory, and the like are integrated may be adopted. In this case, the processor and the memory are located at the same SoC (integrated circuit). Therefore, the “processor” and the “memory” herein may at least encompass both of configurations independent of each other and an integrated configuration.

Communication unit 106 transmits and receives data to and from another game device 100, management server 200, relay server 300, or the like over network 4.

Communication unit 106 may communicate data with another game device 100 or the like over the Internet as exemplary network 4. Network 4 may be a wireless network in conformity with Bluetooth®, ZigBee®, wireless LAN (IEEE 802.11), or the like.

Camera interface 108 mediates data transmission to camera 118 and data reception from camera 118. Connection of camera interface 108 to camera 118 may be wired connection or wireless connection.

Input unit 116 accepts a user operation. Input unit 116 includes, for example, a keyboard, a mouse, a game controller, a touch pad, and/or the like. Input unit 116 may be an interface with a device (for example, a game controller) configured to accept a user operation. In other words, the device configured to accept a user operation may be located outside game device 100.

Display 120 shows an image or a video image generated as a result of processing by processor 102. Display 120 includes, for example, a liquid crystal display (LCD), an organic EL display, or the like. Display 120 may be located outside game device 100. In this case, game device 100 may include an interface circuit with display 120.

Microphone 122 is arranged at a housing or the like of game device 100 and collects sound to generate a sound signal. Speaker 124 is arranged at the housing or the like of game device 100 and generates sound from a sound signal. At least one of microphone 122 and speaker 124 may be located outside game device 100.

Camera 118 generates camera data (moving image data or still image data) resulting from image capture of a subject, in accordance with a command from game device 100 or a predetermined condition. Camera 118 includes, for example, an image capture element such as a charge-coupled device (CCD) image sensor or a complementary metal oxide semiconductor (CMOS) image sensor. A lens may be arranged in a stage preceding the image capture element.

Camera 118 may be, for example, a camera for video chat. Camera 118 may be a dedicated camera connectable only to a specific device or a general-purpose camera connectable to any device. A plurality of cameras 118 may be connectable to game device 100. Furthermore, game device 100 may use a camera of another information processing device (for example, a smartphone). The configuration for game device 100 to use camera 118 is thus not limited.

### [C. Exemplary Software Configuration of Game Device 100]

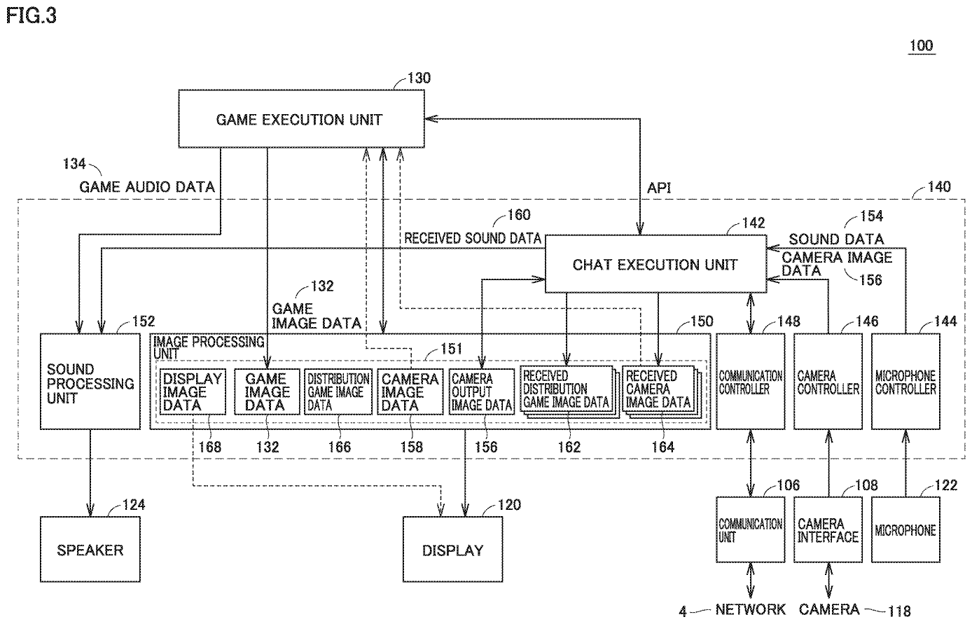

A schematic diagram showing an exemplary software configuration of game device 100 according to the present embodiment will be described with reference to FIG. 3. Referring to FIG. 3, in game device 100, system program 112 including chat application 114 and game application 126 are simultaneously executable. “Being simultaneously executable” means that a plurality of applications or programs are executed in parallel and does not limit execution timing or the like.

Game device 100 includes a system module 140 and a game execution unit 130 by way of example of a software component. System module 140 may be implemented by execution of system program 112 by one or more processors 102. System module 140 can also be referred to as running system program 112. Game execution unit 130 may be implemented by execution of game application 126 by one or more processors 102. Game execution unit 130 can also be referred to as running game application 126.

Game execution unit 130 proceeds with a game based on a user operation and outputs game image data 132 and game audio data 134. Game image data 132 may include, for example, a plurality of types of image data different in image quality, resolution, or frame rate.

System module 140 provides a basic function necessary in game device 100. System module 140 includes, for example, a chat execution unit 142. Chat execution unit 142 can also be referred to as running chat application 114.

System program 112 does not have to include at least a part of chat application 114. At least a part of chat application 114 may be an application different from system program 112, similarly to game application 126. In the description below, a part or the entirety of processing performed by system module 140 may be performed by chat execution unit 142. Therefore, in a context of processing performed by system module 140, system module 140 can also be read as chat execution unit 142 and system module 140 can also be read as system module 140 and chat execution unit 142.

System module 140 includes, for example, a microphone controller 144, a camera controller 146, a communication controller 148, an image processing unit 150, and a sound processing unit 152.

Microphone controller 144 generates sound data 154 based on sound collected by microphone 122 or the like.

Camera controller 146 generates camera output image data 156 based on an image captured by camera 118 or the like. Camera controller 146 may be able to control start and stop or the like of image capture by camera 118, or to control a condition (a frame rate, white balance, or the like) for image capture by camera 118.

Communication controller 148 gives a command to communication unit 106 to control data communication with another game device 100 or the like.

Image processing unit 150 can use a storage area 151 for storage of image data. Storage area 151 may use, for example, a partial area of one or more volatile memories 104 or one or more non-volatile memories 110. Image processing unit 150 may be able to perform image processing on one or more pieces of image data.

Storage area 151 may include, for example, an area for storing game image data 132, camera output image data 156, camera image data 158, one or more pieces of received streaming game image data 162, one or more pieces of received camera image data 164, streaming game image data 166, and display image data 168.

Chat execution unit 142 performs processing for communication between users in the group. For example, chat execution unit 142 may perform processing for joining or leaving the designated group in accordance with a user operation.

Chat execution unit 142 may generate and transmit communication data 10 based on at least one of sound data 154, streaming game image data 166, and camera image data 158 as processing for streaming. Streaming game image data 166 includes an image to be streamed to another game device 100. “Stream” may mean, for example, direct or indirect transmission by a certain game device 100, of some data to one or more other game devices 100. “Stream” may be read as “transmission” and vice versa.

Chat execution unit 142 may cause received streaming game image data 162, received camera image data 164, and the like included in one or more pieces of communication data 10 from one or more other game devices 100 to be stored in storage area 151, as processing for receiving streaming. Chat execution unit 142 may output to sound processing unit 152, received sound data 160 included in one or more pieces of communication data 10 from one or more other game devices 100, as processing for receiving distribution. Sound processing unit 152 may generate a sound signal based on sound data and output the generated sound signal to speaker 124.

Image processing unit 150 may generate display image data 168 by using at least one of game image data 132, camera image data 158, one or more pieces of received streaming game image data 162, and one or more pieces of received camera image data 164 in accordance with a command from chat execution unit 142. Display image data 168 is used for showing an image or a video image on display 120 of the device to which it belongs.

In the present embodiment, the application programming interface (API) is used for interaction (for example, a request and a response or the like) between system module 140 and game execution unit 130. For example, game execution unit 130 may request chat execution unit 142 to respond with data or perform processing in accordance with an instruction system defined in advance as the API. [D. Exemplary Chat Screen]

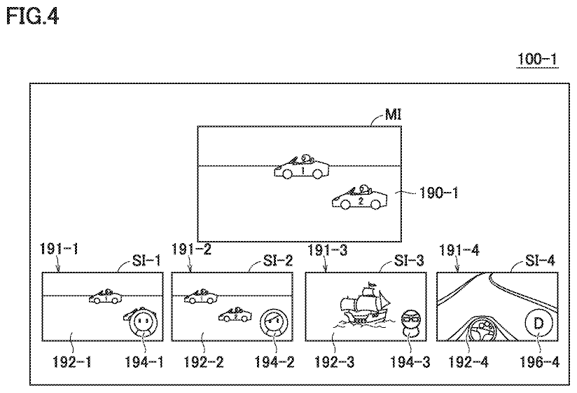

An exemplary chat screen generated in game device 100 according to the present embodiment will be described with reference to FIG. 4.

By way of example, four accounts belong to an identical group and game devices 100-1 to 100-4 correspond to the four respective accounts as shown in FIG. 1. It is assumed in FIG. 4 that game devices 100-1 to 100-3 are streaming camera images and game device 100-4 is not streaming a camera image by way of example. It is assumed that each game device 100 is streaming a game image. A user of each game device may freely be able to start and stop distribution of a camera image and/or distribution of a game image. This is also applicable to distribution of voice of the user or game sound.

FIG. 4 shows an exemplary chat screen shown on display 120 of game device 100-1. The chat screen shown in FIG. 4 is by way of example and a screen configuration of the chat screen created by using communication data 10 is not limited.

As shown in FIG. 4, the exemplary chat screen of game device 100-1 includes a game image 190-1 of a game application running in game device 100-1. The exemplary chat screen of game device 100-1 includes streaming images 191-1 to 191-4 streamed by respective game devices 100-1 to 100-4. Streaming images 191-1 to 191-4 may each include at least one of a streaming game image, a camera image, and an icon image. For example, streaming image 191-1 includes a streaming game image 192-1 and a camera image 194-1 streamed by game device 100-1. By way of example, the camera image is shown as being superimposed on the streaming game image. Since game device 100-4 is not streaming the camera image, an icon image 196-4 indicating the account corresponding to game device 100-4 is superimposed on streaming image 191-4. Icon image 196-4 may also be an exemplary streaming image. The icon image itself may not be streamed, but for example, an identifier of the icon image may be distributed.

In this example, game device 100-1 is streaming game image 192-1 corresponding to game image 190-1 to other game devices 100-2 to 100-4. Game image 190-1 and streaming game image 192-1 do not have to be identical to each other, and for example, streaming game image 192-1 may be lower in image quality and/or frame rate than game image 190-1. As shown in streaming game images 192-2 to 192-4, game devices 100-2 to 100-4 are each executing a game application and streaming an image of the game application. In a chat screen, game image 190-1 is shown in an area MI, and streaming images 191-1 to 191-4 are shown in respective areas SI-1 to SI-4. Area MI is larger in display area than each area SI. Therefore, for the user who operates game device 100-1, operation of the game application executed in game device 100-1 is easy. The number, a size, or a position of area MI and areas SI is not limited. By way of example, an upper limit is set for the number of areas SI. When the number of other game devices which are streaming images is larger than the number of areas SI, the streaming images to be shown in areas SI may manually or automatically be switched. Area SI may be moved, for example, scrolled. For example, in an example shown in FIG. 4, as area SI is scrolled, area SI-1 may move out of the chat screen, whereas an area SI-5 may move into the chat screen.

Which of streaming images 191-1 to 191-4 is to be shown in which of areas SI-1 to SI-4 may be determined based on a predetermined rule. By way of example, in area SI-1 which is the leftmost area in the chat screen, a streaming image streamed by game device 100-1, which is streaming image 191-1 in the present example, may be shown. As the streaming image streamed by game device 100-1 is shown in area SI-1 at a left end, for example, the user of game device 100-1 readily checks whether or not the user himself/herself is streaming the image or readily know contents of the image streamed by the user himself/herself. In areas SI-2, SI-3, and SI-4, for example, the streaming images may be shown based on an order of participation in a chat group, an order of invitation to the chat group, an order of start of distribution of the image, an order of an identifier of each account, or the like.

Streaming images 191-1 to 191-3 include camera images 194-1 to 194-3 streamed by game devices 100-1 to 100-3, respectively. A way of showing the camera image can be set, for example, by each game device 100. By way of example, the camera image may be an image cut out in a circular shape so as to include the face of the user, such as camera images 194-1 and 194-2, or may be an image resulting from cut-out of an upper body or a whole body of the user along a contour from a background, such as camera image 194-3.

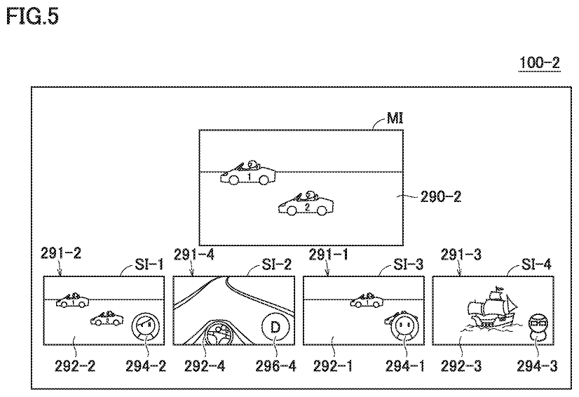

An exemplary chat screen shown on display 120 of game device 100-2 will be described with reference to FIG. 5. In the chat screen of game device 100-2, an image 290-2 of a game application running in game device 100-2 is shown in area MI. In the present example, a streaming game image 292-2 streamed by game device 100-2 is shown in area SI-1. A streaming image 291-4 of game device 100-4, a streaming image 291-1 of game device 100-1, and a streaming image 291-3 of game device 100-3 are shown sequentially in areas SI-2, SI-3, and SI-4, respectively.

In the present example, game device 100-1 and game device 100-2 are executing the same game application and playing a communication game therebetween. Contents of the communication game are not limited, and the communication game may be a shooting game, an action game, a puzzle game, a board game, or the like. In the present example, the game application being executed by game device 100-1 and game device 100-2 is a race game and the game devices are racing. In the game, game device 100-1 joins the game as a player 1 and game device 100-2 joins the game as a player 2. “Player 1” or “player 2” may be a role in any game. For example, “player 1” may have the right to determine a course of the race or to determine whether or not to start the race. For example, “player 1” may be shown above or to the left of “player 2” in a menu screen or the like in the game. For example, “1” is provided to a cursor for “player 1” to move for selection of an item and “2” may be provided to a cursor for “player 2” to move for selection of an item.

By way of example, while game device 100-1 and game device 100-2 are executing the communication game as described above, a display position of the streaming image within the chat screen may desirably be a specific position. For example, in the example shown in FIG. 4, streaming image 191-2 of game device 100-2 corresponding to player 2 is shown to the right of streaming image 191-1 of game device 100-1 corresponding to player 1, and the order of display corresponds to a player number. Therefore, for the user of game device 100-1, for example, playing of the game while the user checks a game status of player 2 is easy or communication relating to contents of the game with the user of game device 100-2 is easy. In the chat screen of game device 100-2 shown in FIG. 5, on the other hand, a streaming image 291-2 corresponding to player 2 is shown in leftmost area SI-1, and streaming image 291-1 corresponding to player 1 is shown in area SI-3 with area SI-2 lying therebetween. Therefore, there is room for improvement in user experiences for the user of game device 100-2. In the present embodiment, the display position of the streaming image can be determined based on the running game application.

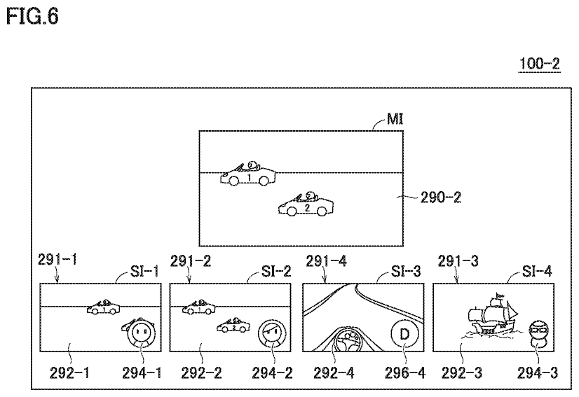

An exemplary chat screen of game device 100-2 will be described with reference to FIG. 6. A state in which the display position of the streaming image is determined based on the running game application is shown. As shown in FIG. 6, streaming image 291-1 corresponding to player 1 is shown in area SI-1 at the left end and streaming image 291-2 corresponding to player 2 is shown in area SI-2 to the right of area SI-1. In other words, in the chat screen of game device 100-1 shown in FIG. 4 and the exemplary chat screen of game device 100-2 shown in FIG. 6, at least the streaming image corresponding to player 1 and the streaming image corresponding to player 2 are the same in positions of areas SI where the streaming images are shown. Therefore, the user of game device 100-1 and the user of game device 100-2 can share game experiences, or it is less likely that streaming images they see when they hold a conversation such as “look at this area SI” are different.

In the examples shown in FIGS. 4 and 6, streaming images shown in area SI-3 and area SI-4 are different between game device 100-1 and game device 100-2. Since game device 100-3 and game device 100-4 corresponding to these streaming images are not playing the communication game with game device 100-1 or game device 100-2, they do not have to be identical in display positions of the streaming images. The display positions also of the streaming images of the game devices which are not playing the communication game together may be determined such that the display positions thereof in the chat screen of each game device are identical.

Though the streaming image of game device 100-1 is shown in area SI-1 and the streaming image of game device 100-2 is shown in area SI-2 in each of the examples shown in FIGS. 4 and 6, limitation as such is not intended. For example, the game application determines the order of display such that the streaming image of game device 100-2 is shown to the right of the streaming image of game device 100-1, whereas in which area SI the streaming image is to be shown does not have to be determined based on the game application. Determination of the display position may include determination only of the order.

The display position may be determined, for example, such that the streaming image of a certain subject game device is arranged in area SI-1 and the streaming image of the game device with which the subject game device plays the communication game together is shown adjacently thereto. For example, the position of the streaming image in the chat screen of game device 100-1 may be set to the position shown in FIG. 4, and in the chat screen of game device 100-2, streaming image 291-2 of game device 100-2 may be shown in area SI-1 and streaming image 291-1 of game device 100-1 may be shown in area SI-2 adjacent thereto.

For example, for one of game device 100-1 and game device 100-2, the display position of the streaming image may be determined based on the game application, and for the other thereof, the display position of the streaming image does not have to be determined based on the game application.

The display position of the streaming image determined based on the game application may or may not be maintained while the game application is running. For example, the game application once determines the display position of the streaming image, and thereafter may change the display position of the streaming image even while the game application is running, based on a status of the chat application such as on and off of distribution by each game device or a status of participation in the chat group by way of example.

A technique to determine the display position of the streaming image by the game application is not limited. By way of example, the display position of the streaming image may be determined based on a state of execution of the game application. The state of execution of the game application includes, for example, correspondence between game device 100 and the player as set forth above. The state of execution of the game application includes, for example, a rank in the communication game. For example, the display position may be determined in accordance with an overall rank or the like when transition from a first game such as a first race to a second game such as a second race is made, or the display position may be determined in real time in accordance with the rank in the first game during the first game such as the first race. Alternatively, in an example where the communication game is a team game, the state of execution of the game application may include a status of grouping of players into teams. For example, the display positions of the streaming images of friendly players may be set to positions adjacent to each other. For example, the state of execution of the game application may include positions of and/or a distance between players in the communication game.

In the chat screens of game device 100-3 and game device 100-4, the streaming image of which of game devices is shown in each of areas SI-1 to SI-4 is not limited. Similarly to game device 100-1 and game device 100-2, also in the chat screens of game device 100-3 and game device 100-4, the streaming image of game device 100-1 may be shown in area SI-1 and the streaming image of game device 100-2 may be shown in area SI-2. Alternatively, the streaming image of game device 100-3 or 100-4 may be shown in area SI-1, and the streaming image of game device 100-1 and the streaming image of game device 100-2 may be shown in area SI-2 and area SI-3, respectively.

Alternatively, the display position of the streaming image of each game device may be determined regardless of the game application running in game device 100-1 or game device 100-2.

### [E. Exemplary Processing]

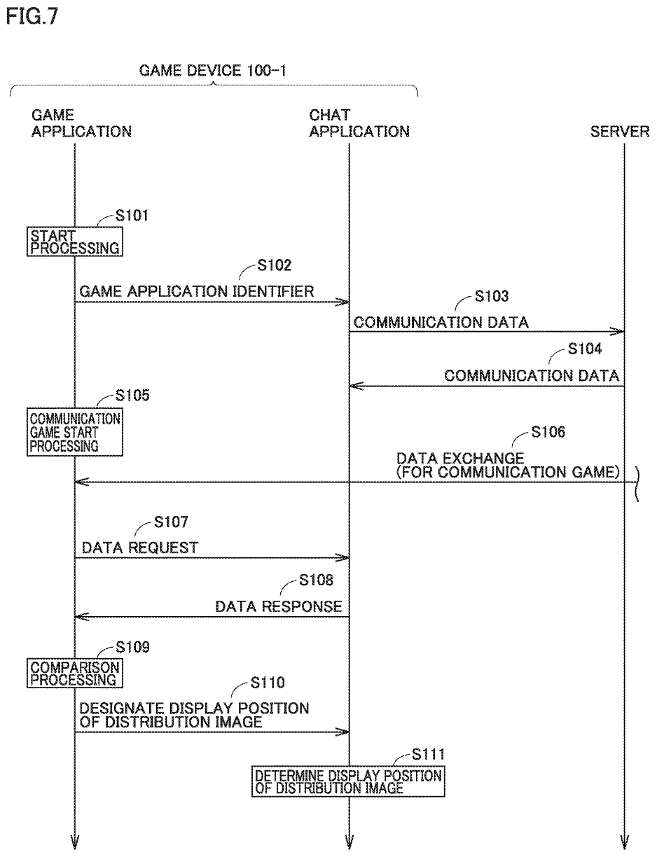

A sequence showing exemplary processing according to the present embodiment will be described with reference to FIG. 7. Processing described in the present embodiment may include other types of processing or does not have to include a part of processing. The order of performing processing is by way of example. For example, a plurality of types of processing may be performed in parallel, or some processing may be performed in the order reverse to the order in the description. Though processing is divided in units of steps for the sake of convenience of description, any unit of division may be applicable. A plurality of steps may be integrated, or a single step may be divided into a plurality of steps. This is also similar in the description which will follow.

FIG. 7 shows the “game application” and the “chat application” running in game device 100-1 for the sake of convenience of description. They may be regarded, for example, as game execution unit 130 or chat execution unit 142. As set forth above, a part of processing may be performed by system module 140. The distinction in terms of wording is merely for the purpose of description, and an entity that performs processing and contents of processing are not limited.

In an initial state in the example shown in FIG. 7, the chat application has already been running in game device 100-1 and game device 100-1 has joined the chat group the same as the chat group which game device 100-2 to game device 100-4 have joined. Game device 100-1 has not yet executed the game application. Game device 100-1 is about to execute the communication game of the game application the same as the game application executed by game device 100-2.

Game device 100-1 executes the game application in accordance with a user operation (S101). The chat application then obtains a game application identifier for identification of the running game application (S102). The game application identifier may be obtained from the game application based on a request from the chat application or may voluntarily be outputted by the game application. Rather than direct output of the game application identifier from the game application to the chat application, the running game application may have the game application identifier stored in the memory and the chat application may read the identifier from the memory. Similarly, also in other processing, data may directly or indirectly be exchanged between applications or with a server.

The chat application transmits communication data including the obtained game application identifier to the server (S103). The server may be management server 200 and/or relay server 300, or another server. The chat application then obtains the communication data from the server. The obtained communication data may include information on other game devices 100-2 to 100-4 such as the identifier of the game application running in each of the game devices or information on a specific account that has joined the chat group. The obtained communication data may include information on game device 100-1.

The communication data may regularly be exchanged between the chat application and the server at predetermined time intervals or exchanged when the state changes in each of game devices 100-1 to 100-4 or the server.

When game device 100-1 executes the communication game included in the game application in accordance with the user operation (S105), it exchanges data necessary for playing the communication game with another game device. The data may directly be exchanged with another game device or with the server being interposed. The server may be a server to or from which the chat application transmits or obtains data, or another server.

Game device 100-1 obtains information on a game device, for example, with which game device 100-1 plays the communication game together, by data exchange for the communication game (S106). In the present example, information specifying that a game device with which the communication game is played together is game device 100-2 is obtained. Game device 100-1 may obtain the information on the game device with which the communication game is played together directly from the game device with which the communication game is played together, or with the server being interposed.

The game application requests the chat application to give data on the chat (S107). By way of example, the request for information specifying the game device that has joined the chat group the same as the chat group which game device 100-1 has joined or data including the identifier of the game application running in each game device is issued. In response to the request, the chat application responds to the game application (S108). Though a technique for issuance of the request to the chat application by the game application is not limited, the API is used in the present embodiment.

The game application compares data obtained from the chat application with data obtained for the communication game (S109). Game device 100-1 can consequently determine that game device 100-2 with which game device 100-1 is about to play the game together has joined the same chat group. The technique for specifying that a counterpart with which a game device is about to play or playing a communication game and a counterpart with which the game device is about to chat or chatting are the same is not limited as above. For example, the game application may output to the chat application, information for identifying the counterpart with which the communication game is played, and the chat application may respond with “YES” when that counterpart is included in the same chat group.

The game application then designates in the chat application, the display position of the streaming image of game device 100-1 and the display position of the streaming image of game device 100-2 by way of example (S110). The chat application determines the display position of the streaming image based on designation (S111). For example, when the designated display position of the streaming image is different from the previous display position, the display position of each streaming image is changed.

Such processing may be performed in each game device 100. Specifically, the display position of the streaming image is determined in each game device 100, and consequently, for example, processing for determining the display positions of the streaming images in game devices which are playing the communication game may similarly be performed. Alternatively, in the example shown in FIG. 7, the game application or the chat application may transmit data designating the display position of the streaming image to another game device such as game device 100-2. Game device 100-2 may determine the display position of the streaming image in the chat application based on the data received from game device 100-1. Alternatively, the server may determine the display position of the streaming image in each game device 100. For example, the server may determine which game devices 100 that have joined the same chat group are executing the communication game and may give a designation of the display positions of the streaming images to a specific game device or all game devices based on a result of determination. By way of example, in this case, exchange of data using the API does not have to be performed between the game application and the chat application.

### [F. Other Modifications]

The display position of the streaming image may be determined based on the running game application only when a specific communication game among a plurality of communication games included in the game application is executed. By way of example, the game application may include a communication game in coordination with the chat application and a communication game not in coordination therewith. The communication game not in coordination with the chat application can also be played with another game device that has joined the same chat group while the chat application is running. Then, only when the communication game in coordination with the chat application is being executed, the display position of the streaming image is determined based on the game application. The communication game in coordination with the chat application may generate, for example, the game image using camera image data and/or received streaming image data.

Some notification may be issued to the user when the display position of the streaming image is determined based on the running game application. For example, the notification may be given unfailingly or when the display position of the streaming image is changed from the current position. The notification may include a button interface for approval by the user, of determination of the display position. When the user gives approval, the display position of the streaming image is set, for example, changed, and when the user rejects determination, the display position of the streaming image may be, for example, maintained at the current position.

In the examples shown in FIGS. 4 and 6, there are four areas SI where the streaming images are shown and game device 100-3 and game device 100-4 corresponding to area SI-3 and area SI-4, respectively, execute different game applications. Game device 100-3 and game device 100-4 may execute a communication game in the game application different from the game application running in game device 100-1 and game device 100-2, or may execute a different communication game in the game application the same as the game application running in game device 100-1 and game device 100-2. At this time, also in game device 100-3 and/or game device 100-4, the display position of the streaming image may be determined based on the running game application. In the chat screens of game device 100-3 and game device 100-4, the streaming images of game device 100-1 and game device 100-2 may have already been shown in area SI-1 and area SI-2 based on the game application running in game device 100-1 and game device 100-2. At this time, the streaming images of game device 100-3 and game device 100-4 may be shown in an area except for area SI-1 and area SI-2 such as area SI-3 and area SI-4. Alternatively, game device 100-3 and game device 100-4 may show, for example, the streaming images of game device 100-3 and game device 100-4 in area SI-1 and area SI-2, respectively, under such a rule that, while game device 100-3 and game device 100-4 are executing a communication game, a left end side of areas SI is preferentially used as the display position of the streaming image of the communication game including game device 100-3 itself and game device 100-4 itself.

The streaming image the display position of which is determined based on the game application may be only the streaming image of others. A manner of display of the streaming image of a certain subject game device may be different from a manner of display of the streaming images of others in the chat screen. For example, the streaming image of the subject game device may be shown as being smaller than the streaming images of others, or may be shown with a frame in a different color being added thereto. In the chat screen, the streaming image of the subject game device does not have to be shown.

The position of area SI where the streaming image is to be shown is not limited. A plurality of areas SI may be located as being vertically aligned or located around the periphery to surround the center.

The number of areas SI where streaming images are to be shown may be smaller than the number of game devices that can join the chat group. By way of example, area SI may be occupied by a game device earlier in timing of start of streaming. In an example where area SI has already been used by another game device, for example, an icon corresponding to a remaining game device may be shown in the chat screen. When a game device not including such area SI is included in a plurality of game devices that execute the communication game, at least the display position of the icon or the like of the game device is determined not based on the game application but may be, for example, maintained.

The display position of the streaming image may be determined based on the game application also when the communication game with the game device that has joined the same chat group is not being executed. The chat application may determine the display position of the streaming image, for example, in response to a request using the API, regardless of whether or not the game application running in the game device is playing the communication game. The game application may be able to issue a request for the display position of the streaming image by using the API, regardless of whether or not the game application is playing the communication game with the game device that has joined the same chat group. The chat application may determine the display position of the streaming image based on the fact that the game application running in the game device is playing the communication game with the game device that has joined the same chat group. The game application may be able to issue, for example, the request using the API to the chat application only when it is playing the communication game with the game device that has joined the same chat group.

Each processing may be provided by cloud computing. For example, the game image may be generated or streamed not by the information processing device operated by the user but by the server. In such a case as well, distribution is based, for example, on the user operation on the information processing device, and therefore it can be said that the “information processing device streams the image.” This is also applicable to execution of the game application or the chat application.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising:
one or more memories storing instructions that, when executed, cause one or more processors to perform operations comprising
performing a chat with one or more other devices,
showing a chat screen including a streaming image of at least one of the one or more other devices that is performing the chat, and
determining a display position of the streaming image within the chat screen based on a running game application.

2. The system according to claim 1, wherein
positions of a plurality of areas where streaming images are shown within the chat screen are defined in advance, and
the operations comprise determining based on the running game application, in which of the areas the streaming image of which of the at least one of the one or more other devices is to be shown.

3. The system according to claim 1, wherein
the operations comprise
providing a communication game with the at least one of the one or more other devices that are performing the chat, and
determining the display position of the streaming image of the at least one of the one or more other devices that is together executing the communication game.

4. The system according to claim 3, wherein
the determined display position is identical to the display position of the streaming image in the at least one of the one or more other devices that is together executing the communication game.

5. The system according to claim 3, wherein
the operations comprise determining the display position of the streaming image such that streaming images of a plurality of devices among the other devices that are together executing the communication game are vertically or laterally adjacent.

6. The system according to claim 3, wherein
the operations comprise determining the display position of the streaming image within the chat screen, based on a state of execution of the running game application.

7. The system according to claim 6, wherein
the state of execution of the game application is correspondence between a plurality of players and a plurality of devices among the other devices in the game application.

8. The system according to claim 6, wherein
the state of execution of the game application varies while the game application is running, and the display position of the streaming image within the chat screen varies in correspondence with variation in the state of execution.

9. The system according to claim 1, wherein
the operations comprise determining the display position of the streaming image in accordance with a request using an application programming interface (API) from the running game application.

10. The system according to claim 1, wherein
the streaming image comprises a game image of the at least one of the one or more other devices.

11. One or more non-transitory computer-readable storage media having stored therein instructions that, when executed, cause one or more processors of a device to perform chat operations comprising:
performing a chat with one or more other devices;
showing a chat screen including a streaming image of at least one of the one or more other devices that is performing the chat; and
determining a display position of the streaming image within the chat screen based on a running game application.

12. The non-transitory computer-readable storage media according to claim 11, wherein
positions of a plurality of areas where streaming images can be shown within the chat screen are determined in advance, and
the operations comprise determining based on a running game application, in which of the areas the streaming image of which of the at least one of the one or more other devices is to be shown.

13. The non-transitory computer-readable storage media according to claim 11, wherein
the operations comprise determining the display position of the streaming image in accordance with a request using an application programming interface (API) from the running game application.

14. The non-transitory computer-readable storage media according to claim 11, wherein
the streaming image comprises a game image of the at least one of the one or more other device.

15. A method comprising:
performing a chat with one or more devices;
showing a chat screen including a streaming image of at least one of the one or more other devices that is performing the chat; and
determining a display position of the streaming image within the chat screen based on a game application that is being executed.

16. The method according to claim 15, wherein
positions of a plurality of areas where streaming images can be shown within the chat screen are determined in advance, and
the method comprises determining based on the running game application, in which of the areas the streaming image of which of the at least one of the one or more other devices is to be shown.

17. The method according to claim 15, comprising determining the display position of the streaming image in accordance with a request using an application programming interface from the running game application.

18. The method according to claim 15, wherein
the streaming image comprises a game image of the at least one of the one or more other devices.

19. One or more non-transitory computer-readable storage media having stored therein instructions that, when executed, cause one or more processors of a device to perform chat operations comprising
performing a chat with one or more other devices;
showing a chat screen including a streaming image of at least one of the one or more other devices that is performing the chat;
receiving a request from a game application running in the device; and
determining a display position of the streaming image within the chat screen based on the request.

20. One or more non-transitory computer-readable storage media having stored therein instructions that, when executed, cause one or more processors of a device to perform game operations comprising:
executing a game;
receiving data from a chat application running in the device; and
transmitting to the chat application based on the data, a request to designate a display position of a streaming image of at least one of the one or more other devices that is performing a chat, the streaming image being included in a chat screen shown by the running chat application.
